(19) United States
(12) Patent Application Publication
(10) Pub. No.: US 2008/0066056 A1
(43) Pub. Date: Mar. 13, 2008

(54) Inspection Apparatus, Program Tampering Detection Apparatus and Method for Specifying Memory Layout

(75) Inventor: Keisuke Inoue, Kanagawa (JP)

Correspondence Address: KAPLAN GILMAN GIBSON & DERNIER L.L.P., 900 ROUTE 9 NORTH, WOODBRIDGE, NJ, 07095, US

(73) Assignee: SONY COMPUTER ENTERTAINMENT INC., Tokyo (JP)

(21) Appl. No.: 11/850,963

(22) Filed: Sep. 6, 2007

(30) Foreign Application Priority Data
Sep. 8, 2006 (JP) 2006-244702

(51) Int. Cl. G06F 9/44

(52) U.S. Cl. 717/124

(57) ABSTRACT

A debugger 100 is connected to a multi-processor system configured so that each processor autonomously accesses a shared memory and loads a program stored in the shared memory into storage of the processor. An identifier defined uniquely in the system is included in code of the program module in advance. A GUID detector 118 selects an ID-attached instruction, the identifier being described in a field of the instruction, from the memory image of the local memory of the processor to be inspected and extracts the identifier. A code retriever 120 selects code of a program module, corresponding to the extracted identifier, from a code holder 114. A memory layout output unit 122 outputs the code selected by the code retriever 120, while associating the code with a memory address of the module in the local memory.

### BACKGROUND OF THE INVENTION

1. Field of the Invention

The present invention relates to a technology for obtaining information about program code which is loaded into a local memory of any one of the processors in a multi-processor system.

2. Description of the Related Art

Along with the recent development of computer graphics technology, image data which is outputted from an information processing apparatus such as a mainframe, a personal computer or a game device has become more complicated and highly advanced. Constructing a main processor with a multi processor system enables to implement high performance arithmetic processing in those information processing apparatuses. In such a multi processor system, a plurality of tasks are assigned to a plurality of processors respectively and processed in parallel, which improves the computing speed.

In a multi-processor system, each processor may process an instruction or data independently without being controlled by a management processor. With such a structure, information on program code which is loaded into the local memory of any one of the processors in the multi-processor system may be needed for a debugging operation or a detection of program tampering.

### SUMMARY OF THE INVENTION

In this background, a general purpose of the present invention is to provide a technology to obtain information about program code which is loaded into the local memory of any one of the processors in a multi-processor system.

According to one embodiment of the present invention, an inspection apparatus is provided. The inspection apparatus is connected to a multi-processor system, each processor being adapted to autonomously access a shared memory and to load a program module stored in the shared memory into a local memory of the processor. The inspection apparatus comprises: a code holder operative to retain code of all the program modules in the shared memory; a local memory duplication unit operative to duplicate a memory image of the local memory in a processor to be inspected; an identifier detector operative to select an ID-attached instruction, an identifier being described in a field of the instruction, from the memory image and extract the identifier, wherein the identifier is defined uniquely in the multi-processor system and is included in code of the program module; a code retriever operative to select code of a program module corresponding to the identifier, extracted by the identifier detector, from the code holder; and a memory layout output unit operative to output the code selected by the code retriever while associating the code with the memory address of the program module in the local memory of the processor to be inspected.

The term “program module” as used herein refers to a task or a job which constitutes a program. According to the embodiment, an instruction having an identifier for specifying a program module is included in code which constitutes the program module loaded into the local memory of any one of the processors in a multi-processor system. By detecting this instruction, a memory layout in the local memory of any one of the processors can be obtained.

The ID-attached instruction is preferably, an instruction which does not affect the operation of a processor after the instruction is executed. The “ID-attached instruction” represents, for example, a constant-generation instruction, a branch instruction and an NOP instruction.

According to another embodiment of the present invention, a program tampering detection apparatus is provided. The program tampering detection apparatus is connected to a multi-processor system, each processor being adapted to autonomously access a shared memory and to load a program module stored in the shared memory into a local memory of the processor. The program tampering detection apparatus comprises: a local memory duplication unit operative to duplicate a memory image of the local memory in a processor to be inspected; an authentication value detector operative to select an authentication information attached instruction from code of the program module in the memory image and to extract the authentication value, wherein the authentication value is described in a field of the instruction, and wherein the code of the program module includes the authentication value calculated based on the code itself; an authentication value recalculator operative to recalculate an authentication value based on the code of the program module in the memory image; and a tampering determination unit operative to compare the authentication value extracted by the authentication value detector and the authentication value calculated by the authentication value recalculator and determine whether or not the code of the program module is changed.

Optional combinations of the aforementioned constituting elements, and implementations of the invention in the form of methods, apparatuses, systems, recording mediums and computer programs may also be practiced as additional modes of the present invention.

### BRIEF DESCRIPTION OF THE DRAWINGS

FIG. 1 illustrates the entire structure of a multi-processor system.

FIG. 2A and FIG. 2B illustrate a manner in which an application program is configured into a task set.

FIG. 3A and FIG. 3B illustrate a manner in which an application program and data are configured into a job chain.

FIG. 4 illustrates a manner in which each SPU obtains a workload stored in a shared memory.

FIG. 5 illustrates an example of the memory layout of a local memory at a certain point in time.

FIG. 6 illustrates an example of the memory layout of a local memory at a certain point in time.

FIG. 7 illustrates the format of a branch instruction.

FIG. 8 illustrates the format of an NOP instruction.

FIG. 9 illustrates the format of a constant-generation instruction.

FIG. 10 illustrates the structure of a debugger according to an embodiment of the present invention.

FIG. 11 is a flowchart illustrating a procedure for generating a memory layout display in the debugger of FIG. 10.

FIG. 12 illustrates the structure of a program tampering detection apparatus according to another embodiment of the present invention.

FIG. 13 is a flowchart illustrating a procedure for detecting program tampering in the program tampering detection apparatus of FIG. 12.

### DETAILED DESCRIPTION OF THE INVENTION

The invention will now be described by reference to the preferred embodiments. This does not intend to limit the scope of the present invention, but to exemplify the invention.

### First Embodiment

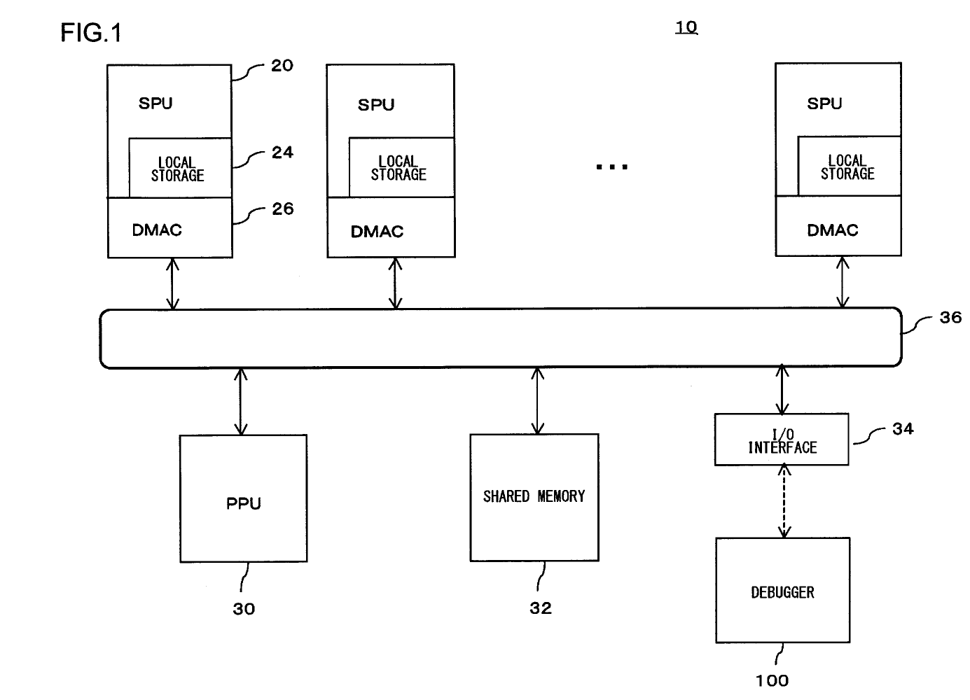

FIG. 1 illustrates the entire structure of a multi-processor system 10 according to an embodiment of the present invention. The multi-processor system 10 includes a power processor unit (PPU) 30 and a plurality of synergistic processing units (SPU) 20. In FIG. 1, one PPU 30 and a plurality of SPUs 20 are depicted. By way of an example, the multi-processor system 10 includes eight SPUs 20. However, a multi processor system with two or more PPUs or with a greater or less number of SPUs may also be used.

An operating system (OS) is executed in the multi-processor system 10. The OS provides a function and an environment for using the whole system efficiently, and controls the entire system. On the OS, application software (hereinafter referred to as an “application”) is executed.

The PPU 30 operates as a controller for the SPUs 20. Each SPU 20 processes data and application independently, in parallel. The PPU 30 and the SPUs 20 may be any processors which can be implemented using any of known or to-be-developed computer architectures. It is preferable that all SPUs 20 be composed of common computing modules and use the same instruction set architecture. However, some of the SPUs 20 may be composed of a different module. The PPU 30 may be located on the same chip, in the same package, on the same circuit board and in the same product as the SPU 20. Alternatively, the PPU 30 may be located at a different location from the SPU 20.

An exchange interface bus (EIB) 36 is a circular bus having two channels in opposite directions. The EIB 36 is connected to a cache of the PPU 30, a DMAC 26 in each SPU 20, and an I/O interface 34 for external communications. The PPU 30 and the SPUs 20 can exchange code and/or data stored in a shared memory 32, via the EIB 36 and the DMACs 26. The shared memory 32 is any type of memory, such as a DRAM, a SRAM or the like.

Each SPU 20 comprises a local memory 24. By way of an example, the capacity of the local memory 24 is 256 kB. Besides the storage, the SPUs 20 comprise, for example, a plurality of 128-bit registers, one or more floating point arithmetic units and one or more integer arithmetic units.

Each SPU 20 comprises the dedicated direct memory access (DMA) controller 26. The DMAC 26 controls, e.g., data transfer and/or data saving between the shared memory 32 and each SPU 20, according to a command from the PPU 30 or an SPU 20.

An SPU 20 operates the DMAC 26 when loading code and data from the shared memory 32 or saving code and data into the shared memory 32. The code and data obtained from the shared memory 32 is loaded into the local memory 24, by which, the SPU 20 can process a program module (i.e., a task or a job).

A debugger 100 is connected to the multi-processor system via an I/O interface 34. The debugger 100 supports detection or a correction of a bug in a program which is being executed in an SPU 20. The debugger 100 comprises functions such as: a) a breakpoint function for stopping the execution of a program at a specified point; b) a step execution function for executing a program while checking the operation step by step; and/or c) a tracing function for observing the state of memory, registers, variables or the like during execution.

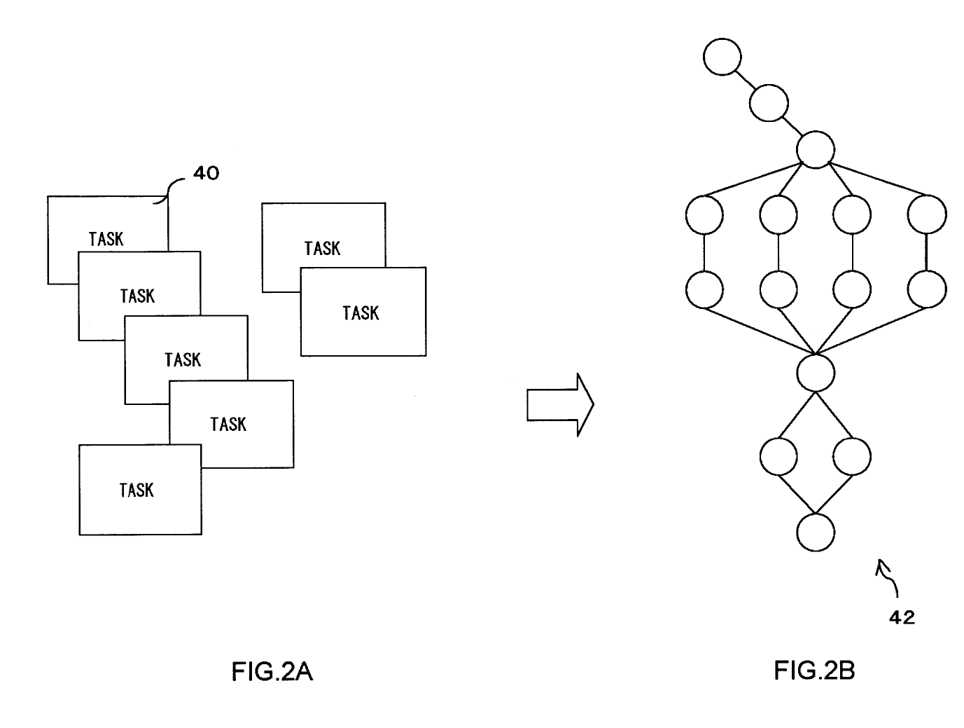

FIG. 2A and FIG. 2B illustrate a manner in which an application program is configured into a task set. The PPU 30 breaks down an application program into a plurality of tasks 40, inspects the dependency among them and constructs the task set 42 from the tasks 40. In FIG. 2B, an open circle represents a task and a line connecting tasks depicts dependency among the tasks. Each of the SPUs 20 executes parallel processing of tasks, based on the task set 42.

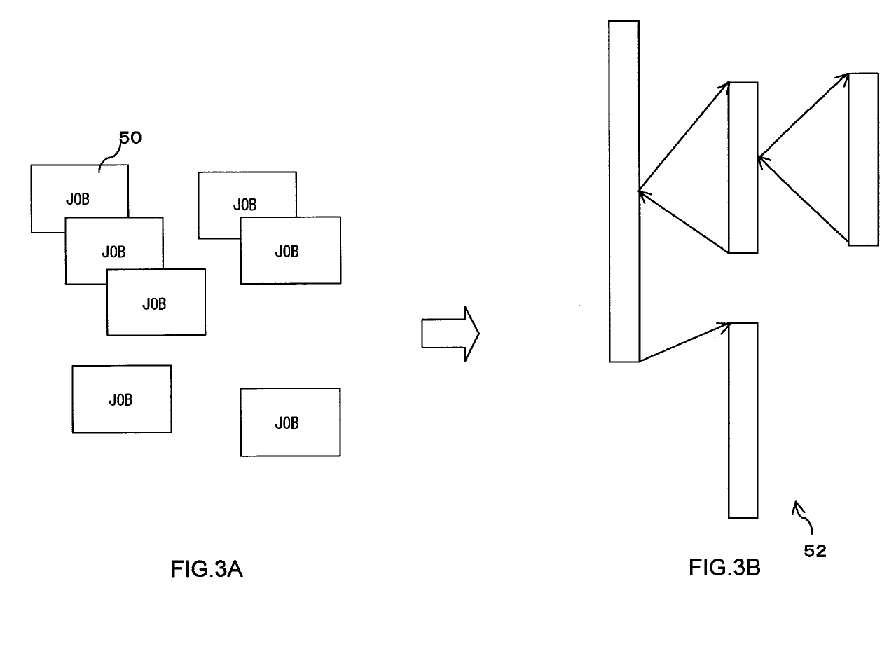

FIG. 3A and FIG. 3B illustrate a manner in which an application program and data are configured into a job chain. The PPU 30 breaks down an application program and data into a plurality of jobs 50, inspects the dependency among the jobs and configures the jobs into a job chain 52. In FIG. 3B, an elongated rectangle indicates a job sequence which consists of a plurality of jobs and an arrow connecting the job sequences indicates a transition of processing. Each of the SPUs 20 processes a job based on the job chain 52.

A task and a job are units of execution of a program, each having a different property and granularity. A task set is a group of tasks (program modules having a large granularity) and a job chain is a group of jobs (program modules having a small granularity). As described below, a policy module which resides in the local memory of an SPU searches for an executable job or task among a task set or a job chain, a job or a task being an unit of execution of a program.

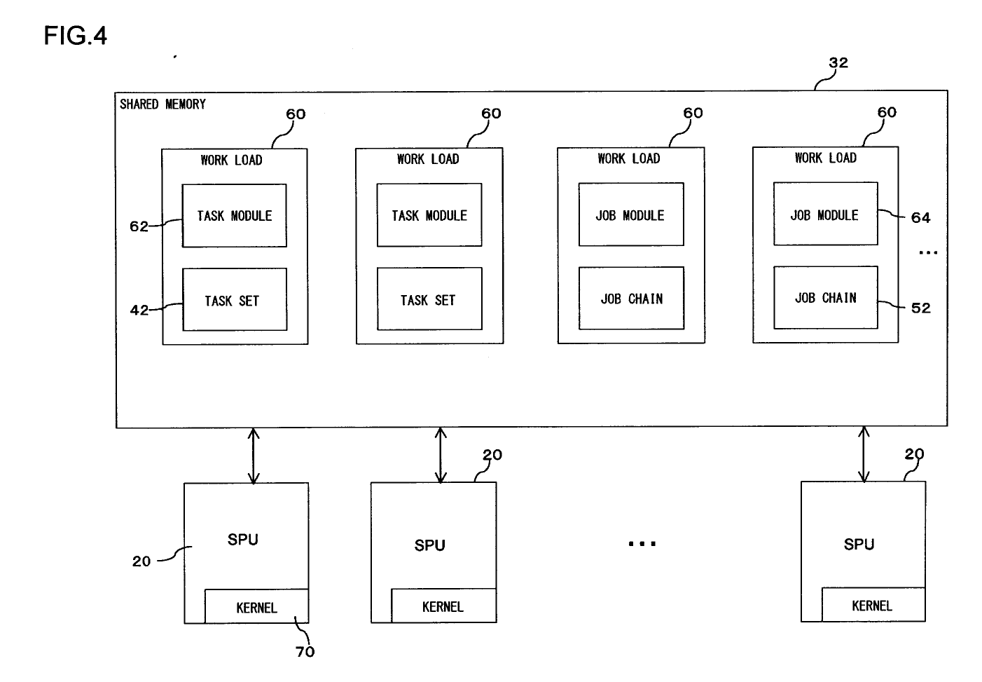

FIG. 4 illustrates a manner in which each SPU 20 acquires a workload 60 which is stored in the shared memory 32.

In the present embodiment, the term “work load” refers to a combination of: a) the task set 42 or the job chain 52; and b) a policy module. The policy module is a manager object which defines the execution scheme of the task or the job. The policy module includes a task module 62 which interprets and executes tasks and a job module 64 which interprets and executes jobs. The task module 62 and the job module 64 are associated with the task set 42 and the job chain 52, respectively.

The PPU 30 stores a work load 60, which is a combination of the task set 42 and the task module 62 or a combination of the job chain 52 and the job module 64, into the shared memory 32. A kernel 70 which resides in the local memory 24 of each SPU 20 copies any one of the work loads 60 from the shared memory 32 to the local memory 24. The loaded task module 62 or job module 64 manages code and data in the local memory 24 in the SPU 20 and executes the task or job. Through this process, the SPU 20 can process any of the programs based on tasks or jobs.

For each work load 60, a priority level to each of the SPUs is given. According to the priority levels, the kernel 70 of each SPU 20 executes the scheduling of the work loads 60. A work load 60 to be processed and notice information are placed in the shared memory 32, the notice information being updated in real-time with information, such as the status of the work load and/or the number of necessary SPUs for the work load. The kernel 70 in each SPU 20 performs polling of this notice information at a proper timing and selects a workload among the executable workloads based on the notice information.

The task module 62 or the job module 64 in the selected workload is DMA-transferred from the shared memory 32 to the local memory 24 in each SPU 20 by a DMAC 26. When a processing of a certain task or a certain job completes, the task module 62 or the job module 64 which is loaded into the local memory 24 determines whether the rest of the tasks or jobs are executable or waiting. Then the task module or the job module loads an executable task or job from the shared memory 32 to the local memory 24 and processes the task or the job. When the processing of the task set 42 or the job chain 52 of the selected workload is completed, the kernel 70 selects a new work load 60 from the shared memory 32. Through this process, each SPU 20 can access the shared memory 32 independently and select the most appropriate workload, without being controlled by the PPU 30.

Basically, the PPU 30 does not perform the scheduling of the SPUs 20. Each SPU 20 independently accesses the shared memory 32, loads a task or a job stored in the shared memory 32 into its local memory and operates accordingly. Through this configuration, a coordinated operation among SPUs is implemented, while each SPU 20 operates highly independently. Thus, the performance of the multi-processor system 10 improves as a whole. In addition, the bandwidth requirement for calling PPU 30 is reduced since the SPUs 20 does not depend on the PPU 30 and operates autonomously.

In the configuration where each SPU 20 operates independently like the multi-processor system 10, the PPU 30 can not keep track of jobs, tasks or policy modules loaded in the local memory 24 of each SPU 20, changing from moment to moment. Therefore, when debugging at the programming stage or when inspecting the performance of a multi processor system, it is not easy for the PPU 30 to obtain information on the layout or the like of the local memory 24 in an SPU 20 during the step-by-step execution of the application program. If the SPU 20 transmits to the PPU 30 information on tasks or jobs which are being executed, the efficiency in operation of the SPU 20 decreases. Further, due to capacity constraints of the local memories 24 in each SPU 20, code or data is loaded into the local memories 24 in small units, such as tasks or jobs. Thus, the layout of the local memories 24 is changing regularly.

Therefore, in the present embodiment, a global unique ID (hereinafter referred to as a “GUID”) which can be defined uniquely in the multi-processor system 10 is assigned to a code which constitutes tasks, jobs, or policy modules which are loaded in the local memory 24 in each SPU 20. By searching for the GUID in a local image of the local memory 24 in an SPU 20 at a certain point in time, the memory layout of the local memory 24 can be obtained.

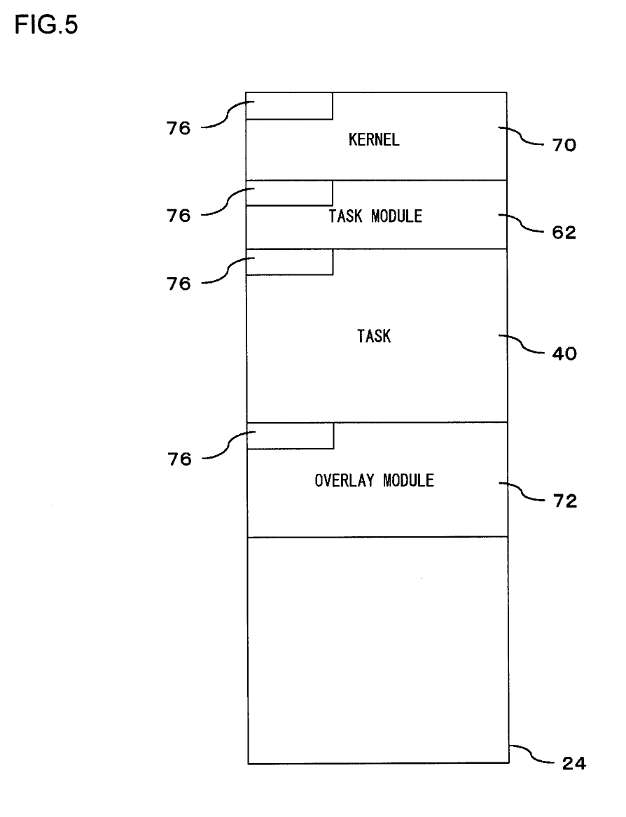

FIG. 5 illustrates an example of a memory layout of a local memory 24 occurring at a certain point in time when the kernel 70 in the SPU 20 loads a workload which consists of a task set 42 and a task module 62. As described above, the kernel 70 resides in the local memory 24. Further, a task 40 and an overlay module 72 are in the local memory 24.

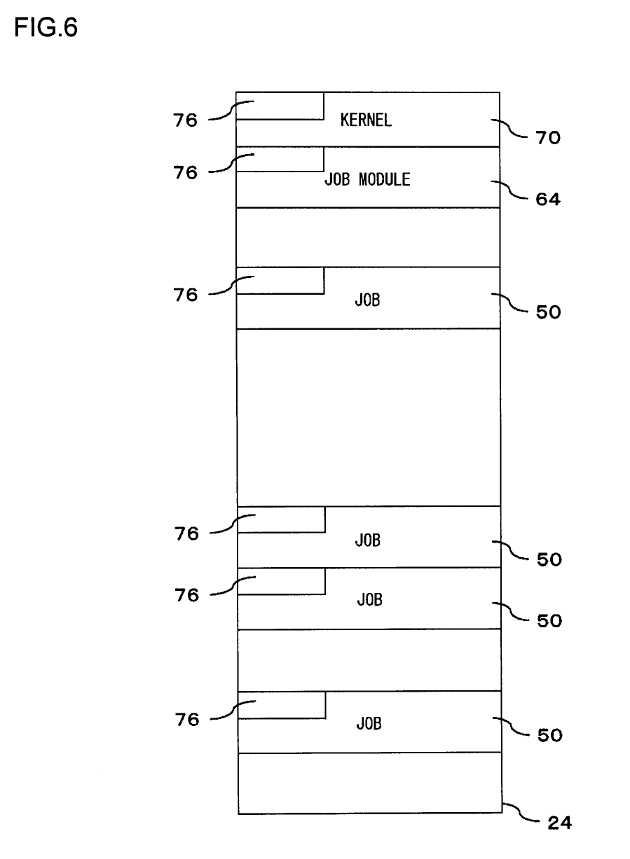

FIG. 6 illustrates an example of a memory layout of a local memory at a certain point in time when the kernel 70 in the SPU 20 loads a workload which consists of a job chain 52 and a job module 64. Besides the kernel 70 which resides in the local memory 24, the job module 64 and a plurality of jobs 50 are in the local memory 24.

Both in FIG. 5 and FIG. 6, GUIDs 76 are allocated at the head of each binary of the task, the jobs and the policy modules to specify the respective locations in the local memory.

The positioning of the GUIDs might cause a problem as described below. That is, when updating a task or a job, if a GUID of an old task or an old job is left without being overwritten, the GUID might be specified by mistake. Furthermore, it should be avoided to put unnecessary padding to align the GUIDs at intervals of, e.g., 128 byte, since the capacity of the local memories 24 is extremely limited.

Therefore, in the present embodiment, the following scheme is further adopted. That is, a GUID is positioned in the head of each binary (a task, a job and a policy module). This allows preventing an old GUID from being left behind after being overwritten. To put a GUID at the head of a task, a job, and a policy module, the GUID is described in an instruction which does not affect the operation of the processor after the execution of the instruction. Then the instruction is appended to the head of the code. This allows binaries to be executed from its head and GUIDs can be overwritten with a small number of instructions. Further, it is not necessary to put padding to align the GUIDs at intervals of 128 byte.

An address in the local memory 24 of the instruction in which a GUID is embedded (hereinafter referred to as an “ID-attached instruction”) is aligned at intervals of predefined byte, e.g., 128 byte. This is because if the positions of GUIDs are not defined, it is required to search the whole local memory to detect GUIDs, thus, the searching time increases. With GUIDs aligned at intervals of 128 byte, it is enough just to search the head of every 128 byte. Thus, the processing speed increases.

It is preferable that a GUID be described separately in a field of a plurality of ID-attached instructions. By arranging a plurality of ID-attached instructions, each of which includes a part of a GUID, in a particular order that never occurs in an ordinary program, an external apparatus (e.g., a debugger) can easily detect the existence of the GUID.

Now, some exemplary ID-attached instructions for embedding a GUID are described more specifically below. The format of these instructions is set to, but not limited to a length of 32 bits.

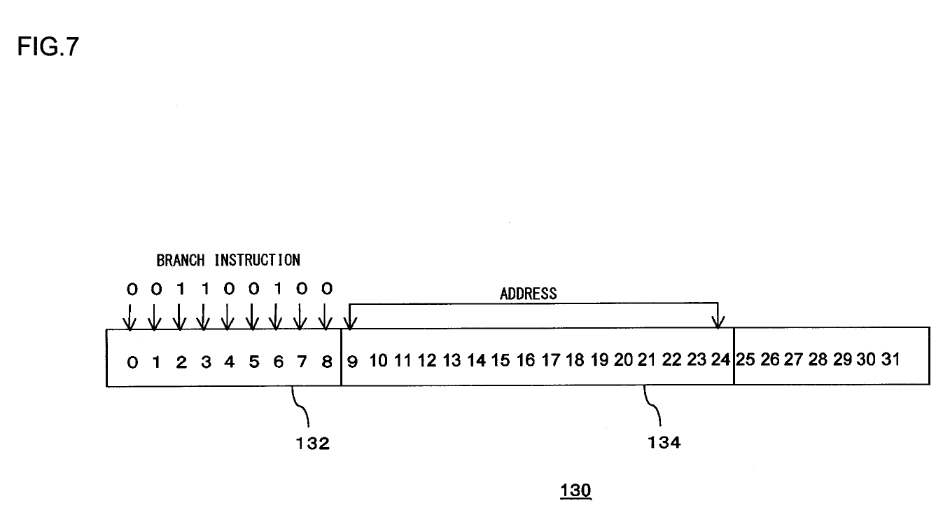

FIG. 7 illustrates the data format of a branch instruction 130. A branch instruction moves the execution to a target instruction specified by an address. The numbers in FIG. 7 indicate bit numbers. In a field 132 which is a range of bit numbers 0-8, binary representing the branch instruction is specified. In a field 134 which is a range of bit numbers 9-24, the address of the target instruction is generally written. GUIDs are described in this field 134, when the branch instruction is used as an ID-attached instruction.

By way of an example, a code sequence wherein a branch instruction is used is shown below. By the branch instruction “br”, a GUID is skipped. Following the branch instruction, a GUID is fed into a pipe line as a dead code and ten-odd cycles of branch penalty are incurred. Nevertheless, it does not affect the execution of the program thereafter.

```
br GUID_END !GUID_START
  .long data0
  .long data1
  .long data2
GUID_END
```

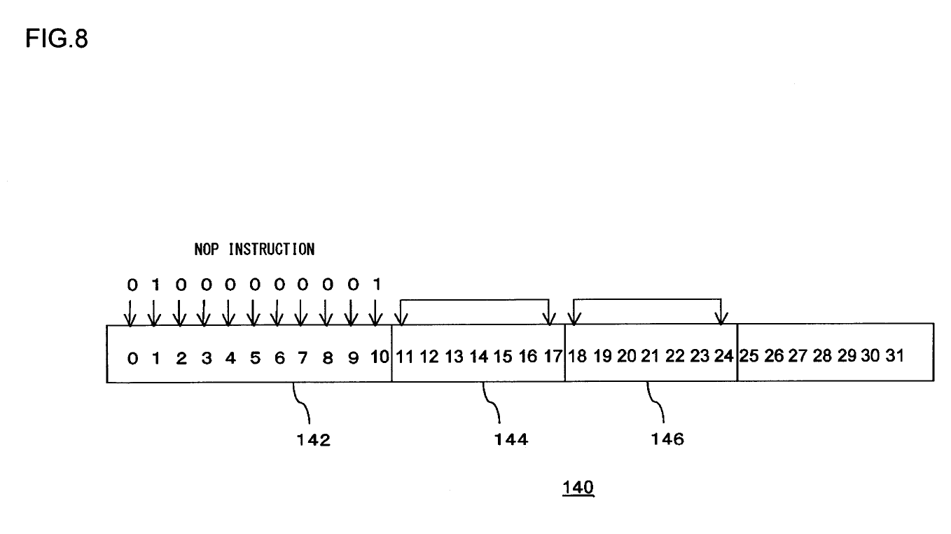

FIG. 8 illustrates the data format of an NOP instruction 140. The NOP instruction has no effect on the execution of a program. The instruction exists to provide implementation-defined control of instruction issuance. In a field 142 which is a range of bit numbers 0-10, binary representing the NOP instruction is specified. A field 144 which is a range of bit numbers 11-17 and a field 146 which is a range of bit numbers 18-24 are fields reserved for the architecture. GUIDs are described in these fields 144 and 146, when the NOP instruction is used as an ID-attached instruction. Since the NOP instruction has no effect on the execution of a program, even with the embedded GUIDs, it does not affect the processing thereafter.

By way of an example, a code sequence wherein NOP instructions are used is shown below: “nop” and “lnop” represent NOP instructions; “data0”˜“data3” are a part of the GUID respectively. One GUID is generated from the four instructions.

nop data0 !GUID_START
lnop data1
nop data2
lnop data3 !GUID_END

An NOP instruction is used, for example, when making a VLIW (very long instruction word) type instruction. A VLIW having a fixed length can be generated by putting an NOP instruction in a field where a significant instruction can not be inserted. Thus, generally, NOP instructions are not generated consecutively. Therefore, by setting the debugger to detect consecutive NOP instructions, these instructions are determined to be ID-attached instructions in which a GUID is embedded.

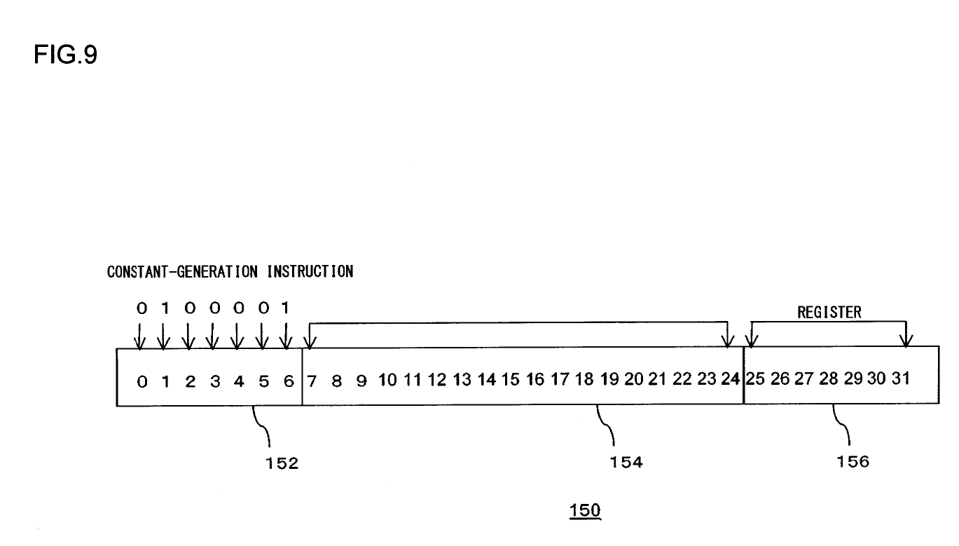

FIG. 9 illustrates the data format of a constant-generation instruction 150. The constant-generation instruction writes an immediate value, such as an address or a constant, to a specified register. In a field 152 which is a range of bit numbers 0-6, binary representing the constant-generation instruction is specified. In a field 154 which is a range of bit numbers 7-24, a constant is specified. A GUID is described in this field 154 when the constant-generation instruction is used as an ID-attached instruction. In a field 156 which is a range of bit numbers 25-31, a register in an SPU is specified. The immediate value is written in the register. The register specified here is preferably, a register on which a special role is not defined in an ABI (Application Binary Interface) and which can be overwritten. By executing a constant-generation instruction, a constant is written in the register of the SPU. However, it does not affect the execution thereafter, since a program which reads a general-purpose register just before writing a constant into the register is not normally generated.

By way of an example, a code sequence wherein constant-generation instructions are used is shown below: “ila” represents a constant-generation instruction; and “$2” indicates a target register. Four constant-generation instructions are arranged consecutively and a field having a length of 16 bits in one instruction is used for a part of GUID. In total, a GUID has a length of 64 bit.

ila $2, 0 !GUID_START
ila $2, 1
ila $2, 2
ila $2, 3 !GUID_END

Generally, a compiler does not generate constant-generation instructions consecutively for one register. Therefore, by setting the debugger to detect consecutive constant-generation instructions, the instructions are determined to be ID-attached instructions in which a GUID is embedded.

One of the ID-attached instructions described above may be used or a plurality of the instructions may be used to describe a GUID. Besides the listed instructions, another instruction which fulfills the requirements described above may be used for describing a GUID.

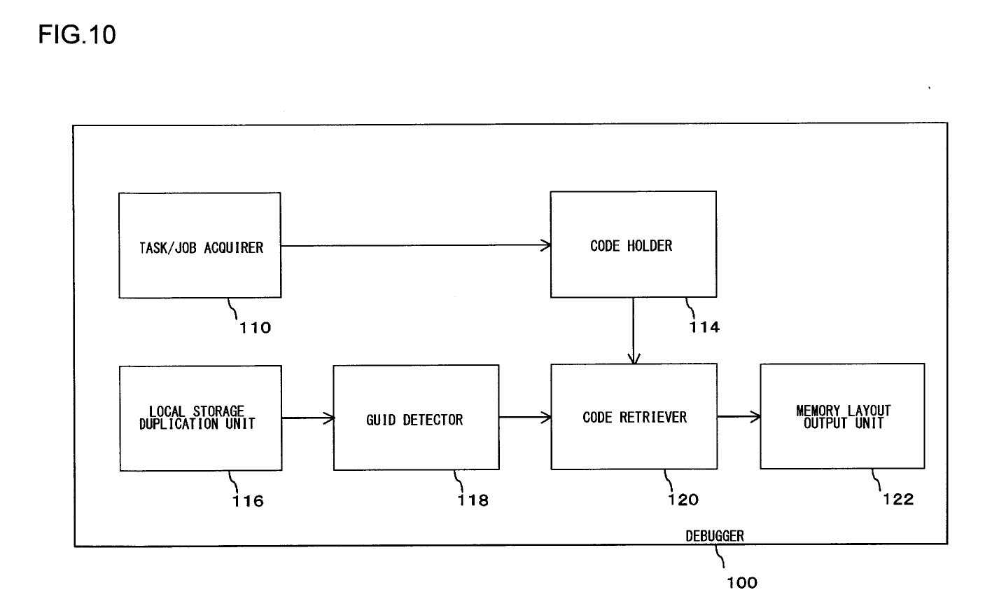

FIG. 10 illustrates the structure of a part of the debugger 100 shown in FIG. 1, the part being involved in a function for outputting a memory layout using GUIDs. The debugger 100 contains a general-purpose computer and a debugger program installed in the computer. In FIG. 10, elements which perform a variety of processes are shown as functional blocks. The blocks may be implemented hardwarewise by elements such as a CPU, a memory or other LSIs, and softwarewise by a computer program loaded into a memory or the like. Therefore, it will be obvious to those skilled in the art that the functional blocks may be implemented in a variety of manners, as hardware only, software only, or a combination of both.

As described above, in the multi-processor system 10, a large number of small programs are scattered throughout the local memories 24 in the SPUs 20. Further, since respective SPUs 20 rewrite the local memories 24 autonomously, the updating status of the memories can not be traced point by point from outside of the SPUs 20. Therefore, the debugger 100 utilizes the GUIDs as means to obtain the memory layout of the local memory 24 in the SPU 20 which is being inspected.

A task/job acquirer 110 obtains code of tasks, jobs and/or policy modules in the shared memory 32. A GUID which is uniquely defined in the multi-processor system 10 has been assigned to respective task, job and policy module in advance. The ID-attached instruction in which the GUID is embedded has been appended to the head of the code. For example, the GUID may have a length of 64 bits. The GUID may be a random number, a value specified by a user or a hash value calculated by using the binary of the code. The code holder 114 retains the code for all of the tasks, jobs and policy modules to which the ID-attached instructions are appended.

The local memory duplication unit 116 duplicates a memory image of the local memory in the SPU being inspected. A GUID detector 118 detects the ID-attached instructions, in which the GUID is embedded, in the memory image and extracts the GUIDs described in predefined fields. The GUID detector 118 determines an instruction to be an ID-attached instruction if, e.g., the instruction appearing at the intervals of 128 bytes forms any one of the instruction sequences described in FIGS. 7-9. The code retriever 120 selects code of the task or the job, corresponding to the GUID extracted by the GUID detector 118, from the code holder 114.

A memory layout output unit 122 outputs the code selected by the code retriever 120, while associating the code with the memory address of the task, the job and/or the policy module in the local memory of the SPU. This makes it possible to refer source code.

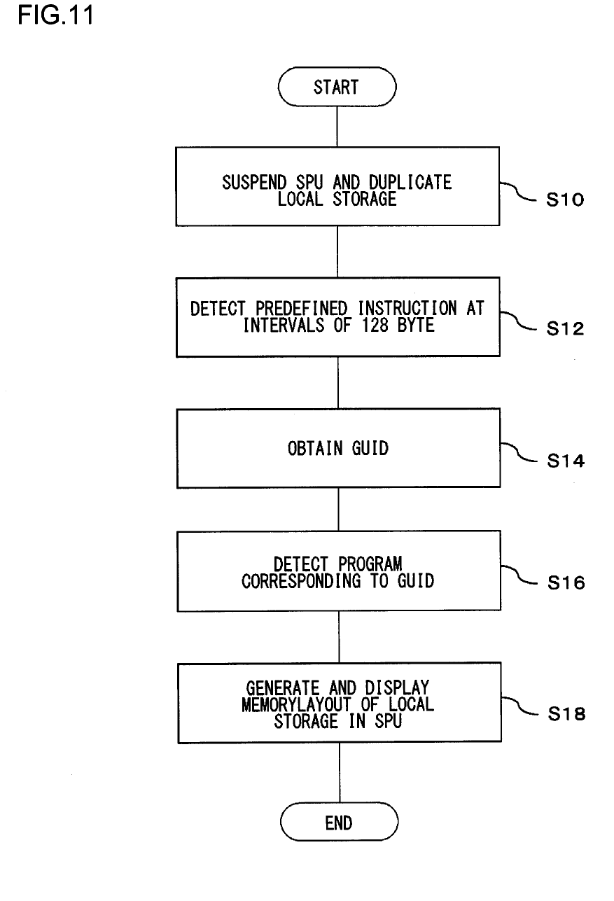

FIG. 11 is a flowchart illustrating a procedure for generating memory layout display in the debugger 100 of FIG. 10. When the debugger 100 suspends the execution of a program in the multi-processor system 10 at a specified point, the local memory duplication unit 116 duplicates the memory image of the local memory 24 in the SPU 20 which is being debugged, via a DMAC 26 (S10). Subsequently, the GUID detector 118 searches the duplication of the local memory at intervals of 128 byte and detects a predefined characteristic instruction sequence (e.g., four consecutive constant-generation instructions starting at any of the heads of each 128 byte) (S12). The GUID detector 118 extracts a part of a GUID from the predefined field of the detected instructions respectively and, by combining the parts, obtains the GUID (S14). At this stage, the GUID of code located at the address occurring at 128 byte intervals in the local memory of the SPU is identified.

The code retriever 120 retrieves a piece of code corresponding to the GUID which is detected in S14 from the code holder 114 (S16). The memory layout output unit 122 combines the pieces of code which correspond to the GUIDs detected in S16, relates the code to address in the local memory, generates a memory layout at the point in time and displays the layout on a display (S18).

As described above, according to the present embodiment, identification information for specifying a program module can be embedded in code which constitutes a program module corresponding to tasks or jobs loaded into the local memory in any one of the processors in the multi-processor system. The GUID, which is identification information, is described in an instruction that does not affect the operation of the processor after the execution of the instruction. This removes the necessity to take any special measures to process a GUID.

Although a GUID itself is described in instructions in this embodiment, an alternative configuration may also be adopted. That is, a pointer for a GUID may be described in a field of an instruction and the actual GUID may be allocated to a location specified by the pointer.

For high-speed search, ID-attached instructions each including a GUID are placed at any positions at intervals of 128 byte in the above description. However, if time permits for the search, the instructions may be placed freely without the limitation. In this case, uniqueness in the instruction sequence are required to allow the debugger to detect GUIDs.

In the above description, four instructions are arranged consecutively and a field having a length of 16 bits in the instruction is used as a part of a GUID. Then a GUID having 64 bit length in total is generated. However, the size of the GUID is not limited to 64 bits. The field for the GUID may also be set variable in length. For example, by changing the number of consecutive ID-attached instructions, the size of the GUID can be changed. By way of an example, for two instructions, the GUID has a length of 32 bits.

In this embodiment, an explanation is given for the debugger which utilizes GUIDs embedded in instructions. Alternatively, GUIDs can be utilized in a performance analyzer which analyzes performance data collected from the multi-processor system and displays the result graphically.

### Second Embodiment

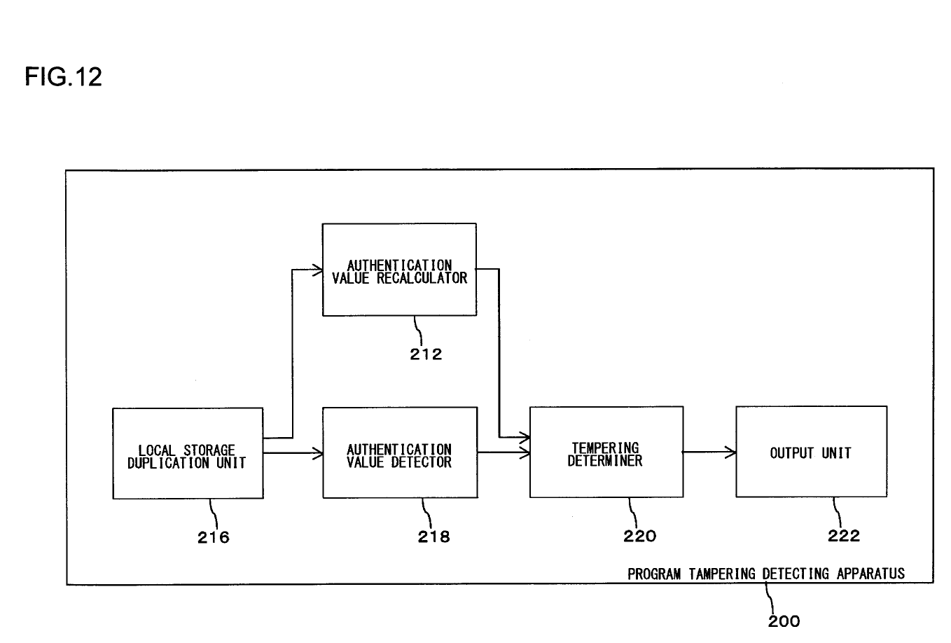

FIG. 12 illustrates the structure of a program tampering detection apparatus 200 according to another embodiment of the present invention. The program tampering detection apparatus 200 is connected to the multi-processor system 10 via an I/O interface 34. The functional blocks as shown in the figure may also be implemented in a variety of manners, by a combination of hardware and software.

In a method to detect program tampering according to the embodiment, instead of a GUID, an authentication value is written in a field in the ID-attached instruction which is described in the first embodiment. The authentication value is calculated from code, which constitutes a program module (i.e., a job or a task). Hereinafter, such an instruction is referred to as an “authentication information attached instruction”

In code which constitutes a task, a job or a policy module, an authentication value calculated beforehand based on the code is included. For example, a checksum has been calculated in advance for each code in increments of a little less than 1 KB. Then, an authentication information attached instruction with the value of the checksum described in a field is appended to the code at intervals of 1 KB.

A local memory duplication unit 216 duplicates a memory image of the local memory in the SPU which is being inspected. An authentication value detector 218 detects an authentication information attached instruction, in which the authentication value is embedded, from the code of a task, a job and/or a policy module in the memory image. Then the detector extracts the authentication value described in a predefined field.

An authentication value recalculator 212 recalculates an authentication value according to the code of the task, the job and/or the policy module in the memory image. A tampering determination unit 220 compares the authentication value extracted by the authentication value detector 218 and the authentication value calculated by the authentication value recalculator 212. Then, the determination unit determines whether or not the code in the task, the job and/or the policy module is tampered. If both authentication values do not coincide with each other, the determination unit determines that the code is tampered. The tampering determination unit 220 may also determine whether or not the number of the authentication values included in the code coincides with a predefined number. An output unit 222 outputs the result of the determination by the tampering determination unit 220 to a display, or the like.

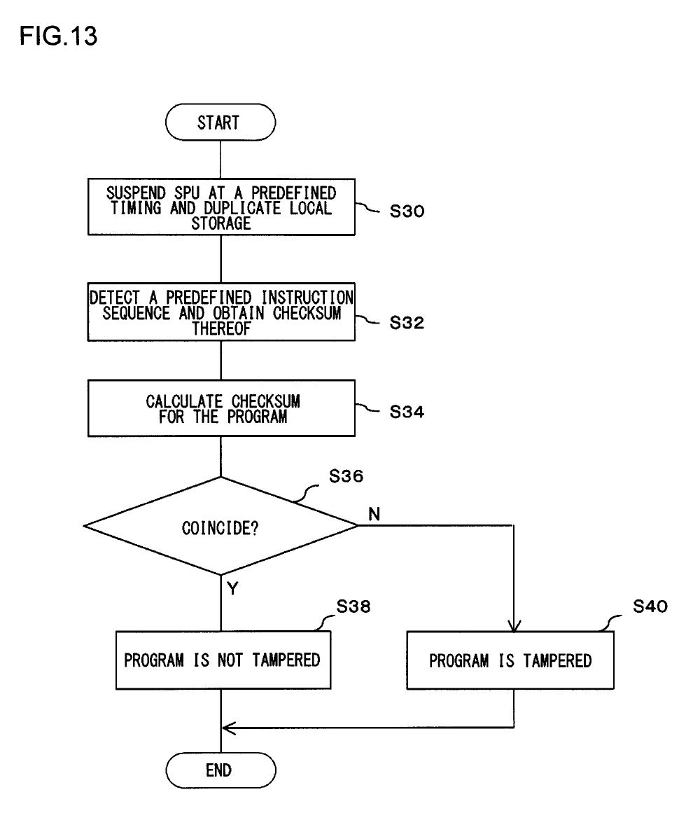

FIG. 13 is a flowchart illustrating a procedure for detecting program tampering in the program tampering detection apparatus 200 of FIG. 12. When the program tampering detection apparatus 200 suspends the execution of a program in the multi-processor system 10 at a specified point, the local memory duplication unit 216 duplicates the memory image of the local memory 24 in the SPU 20 which is being debugged, via the DMAC 26 (S30). Subsequently, the authentication value detector 218 searches the duplication of the local memory and detects an instruction sequence having a predefined characteristic (e.g., four consecutive constant-generation instructions). The authentication value detector 218 extracts a part of a GUID from a predefined field of the detected instructions respectively and combines the parts and obtains the GUID (S32).

The authentication value recalculator 212 recalculates the authentication value according to the code of the task, the job and/or the policy module of which the authentication values are obtained (S34). The tampering determination unit 220 compares the authentication value acquired in S32 and the authentication value calculated in S34 (S36). If the both authentication values coincide with each other (Y in S36), the determination unit determines that the code of the task, the job and/or the policy module are not tampered (S38). If the both authentication values are different (N in S36), the determination unit determines that the code of the task, the job and/or the policy module are tampered (S40).

The description of the invention given above is based upon illustrative embodiments. These embodiments are intended to be illustrative only and it will be obvious to those skilled in the art that various modifications to constituting elements and processes could be developed and that such modifications are also within the scope of the present invention.

Optional combinations of the constituting elements described in the embodiments, and implementations of the invention in the form of methods, apparatuses, systems, computer programs and recording mediums may also be practiced as additional modes of the present invention. The methods illustrated in this specification as flowcharts include parallel processing or individual processing as well as processing executed in time series in accordance with a sequence shown in the flowcharts.

What is claimed is:

1. An inspection apparatus connected to a multi-processor system, each processor being adapted to autonomously access a shared memory and to load a program module stored in the shared memory into a local memory of the processor, the inspection apparatus comprising:
a code holder operative to retain code of all the program modules in the shared memory;
a local memory duplication unit operative to duplicate a memory image of the local memory in a processor to be inspected;
an identifier detector operative to select an ID-attached instruction, the identifier being described in a field of the instruction, from the memory image and extract the identifier, wherein the identifier is defined uniquely in the multi-processor system and is included in code of the program module;
a code retriever operative to select code of a program module corresponding to the identifier, extracted by the identifier detector, from the code holder; and
a memory layout output unit operative to output the code selected by the code retriever while associating the code with the memory address of the program module in the local memory of the processor to be inspected.

2. The inspection apparatus according to claim 1, wherein the ID-attached instruction does not affect the operation of the processor after the execution of the instruction.

3. The inspection apparatus according to claim 2, wherein the ID-attached instruction is a constant-generation instruction.

4. The inspection apparatus according to claim 2, wherein the ID-attached instruction is a branch instruction.

5. The inspection apparatus according to claim 2, wherein the ID-attached instruction is an NOP instruction.

6. The inspection apparatus according to claim 1, wherein the identifier is divided and described in fields of a plurality of the ID-attached instructions.

7. The inspection apparatus according to claim 1, wherein the memory address of the ID-attached instruction in the local memory is aligned at predefined intervals of bytes.

8. The inspection apparatus according to claim 1, wherein an authentication value, calculated by using code of the program module, is described in a field in the ID-attached instruction, instead of the identifier.

9. A computer program product comprising a plurality of program modules for use in a multi-processor system, each processor being adapted to autonomously access a shared memory and to load the program module stored in the shared memory into a local memory of the processor,
wherein an identifier is defined uniquely in the multi-processor system and is attached to code of the program module in advance,
at least one of the instructions included in the code is an ID-attached instruction, the identifier being described in a field of the instruction, and
the position of the program module in the local memory is identified by allowing the identifier to be detected from the code of the program module in the local memory.

10. A program tampering detection apparatus connected to a multi-processor system, each processor being adapted to autonomously access a shared memory and to load a program module stored in the shared memory into a local memory of the processor, the program tampering detection apparatus comprising:
a local memory duplication unit operative to duplicate a memory image of the local memory in the processor to be inspected;
an authentication value detector operative to select an authentication information attached instruction from code of the program module in the memory image and to extract the authentication value, wherein the authentication value is described in a field of the instruction, and wherein the code of the program module includes the authentication value calculated based on the code itself;
an authentication value recalculator operative to recalculate an authentication value based on the code of the program module in the memory image; and
a tampering determination unit operative to compare the authentication value extracted by the authentication value detector and the authentication value calculated by the authentication value recalculator and determine whether or not the code of the program module is tampered.

11. The program tampering detection apparatus according to claim 10, wherein the authentication information attached instruction does not affect the operation of the processor after the execution of the instruction.

12. The program tampering detection apparatus according to claim 11, wherein the authentication information attached instruction is a constant-generation instruction.

13. The program tampering detection apparatus according to claim 11, wherein the authentication information attached instruction is a branch instruction.

14. The program tampering detection apparatus according to claim 11, wherein the authentication information attached instruction is an NOP instruction.

15. The program tampering detection apparatus according to claim 10, wherein the authentication value is divided and described in fields of a plurality of the authentication information attached instruction.

16. The program tampering detection apparatus according to claim 10, wherein the memory address of the authentication information attached instruction in the local memory is aligned at predefined intervals of bytes.

17. A method for specifying a memory layout for use in a multi-processor system, each processor being adapted to autonomously access a shared memory and to load a program module stored in the shared memory into a storage of the processor, comprising:
attaching an identifier defined uniquely in the multi-processor system to code of the a program module;
including at least one ID-attached instruction, the identifier being described in a field of the instruction, into the code as one of the instructions included in the code; and
specifying the positions of the program module in the local memory by detecting the identifier from the code of the program module in the local memory.
